(19) United States
(12) Patent Application Publication
(10) Pub. No.: US 2005/0252875 A1
(43) Pub. Date: Nov. 17, 2005

(54) Air inlet valve of a nipple used for a bottle

(76) Inventors: Miin-Tsang Sheu, Chung Hua (TW); Shang-Jen Chang, Taipei Hsien (TW)

Correspondence Address: Min-Tsang Sheu, 235 Chung-Ho, Box 8-24, Taipei, TW

(21) Appl. No.: 10/846,295

(22) Filed: May 14, 2004

(51) Int. Cl. A61J 9/04

(52) U.S. Cl. 215/11.5

(57) ABSTRACT

An air inlet valve of a nipple used for a bottle has an annular bottom. The air inlet valve has a tapered shape with a flat bottom end. The air inlet valve comprises an air inlet channel vertically penetrates through the air inlet valve and having a tip end; a distal end of the air inlet channel being reduced so as to form a tapered reducing portion; a periphery of the air inlet channel being formed with a tapered cylinder; one side of the tapered cylinder near the bottom of the nipple being thicker than other side of the tapered cylinder for enhancing the structure of the air inlet valve; two valve gates formed at two sides of the flat bottom end; a slit being formed between the valve gates; and the slit being communicated to the air inlet channel.

### FIELD OF THE INVENTION

The present invention relates to nipples, and particular to an air inlet valve of a nipple used for a bottle. The air inlet valve has a preferred check effect so that fluid in the bottle cannot drain out.

### BACKGROUND OF THE INVENTION

When the liquid is sucked from a soft nipple, air must be guided into the bottle to cause the liquid within the bottle can be drained out successfully. Thereby, at least one air inlet valve is installed at a bottom side of the nipple so that the liquid can flow out successfully,

Referring to FIGS. 1 and 1A, generally, the conventional nipple has an air inlet valve 1 with a round and short nose like shape. The end of the air inlet valve 1 has a straight or cruciform slit. The slit communicates to an air inlet channel in the air inlet valve 1. Thereby, the slit is formed as a closable opening. However, this prior art cannot be used for a longer time due to the slit cannot act successfully.

Thereby, with reference to FIGS. 2 and 2A, another nipple is developed with a short and flat-bottom tapered sleeve. The bottom end is formed with two inclined surfaces 2A and 2B so as to form as a tapered portion 21 with a straight end 22. A slit 22A is cut at a middle section of the bottom of the straight end 22 to form two valve gates 21A, 21B. By the tension forces of the two valve gates, the slit can close to prevent fluid from flowing out of the bottle. However, the upper section of each valve gate is thicker than the lower section thereof. Thereby, the strength in the lower section is weaker than that of the upper section so that as the nipple is used for a longer time, the slit cannot be well closed. As a result liquid will drain out from the slit.

### SUMMARY OF THE INVENTION

Accordingly, the primary object of the present invention is to provide an air inlet valve of a nipple used for a bottle which has an annular bottom. The air inlet valve has a tapered shape with a flat bottom end. The air inlet valve comprises an air inlet channel vertically penetrates the air inlet valve and having a tip end; a distal end of the air inlet channel being reduced so as to form a tapered reducing portion; a periphery of the air inlet channel being formed with a tapered cylinder; one side of the tapered cylinder near the bottom of the nipple being thicker than other side of the tapered cylinder for enhancing the structure of the air inlet valve; two valve gates formed at two sides of the flat bottom end; a slit being formed between the two valve gates; and the slit being communicated to the air inlet channel.

The various objects and advantages of the present invention will be more readily understood from the following detailed description when read in conjunction with the appended drawing.

### BRIEF DESCRIPTION OF THE DRAWINGS

FIG. 1 shows a prior art air inlet valve of a nipple.

FIG. 1A is a partial cross section view of FIG. 1.

FIG. 2 is a perspective view of another prior art air inlet valve.

FIG. 2A is an enlarged partial cross section view of the air inlet valve of FIG. 2.

FIG. 3 is a perspective view of the present invention.

FIG. 3A is an enlarged perspective view of the air inlet valve of the present invention.

FIG. 3B is a schematic view showing the formation of the slit according to the present invention.

FIG. 4 is a cross section view of the present invention.

FIG. 4A is an enlarged cross section view of the air inlet valve of the present invention.

FIG. 4B is an enlarged cross section view in another embodiment of the present invention.

FIG. 5A shows the air inlet valve of the present invention, which is viewed from another side of FIG. 4A, where the air inlet valve is closed.

FIG. 5B shows the air inlet valve of the present invention, which is viewed from another side of FIG. 4A, where the air inlet valve is opened.

FIG. 6 shows the force applied structure of the air inlet valve of the present invention.

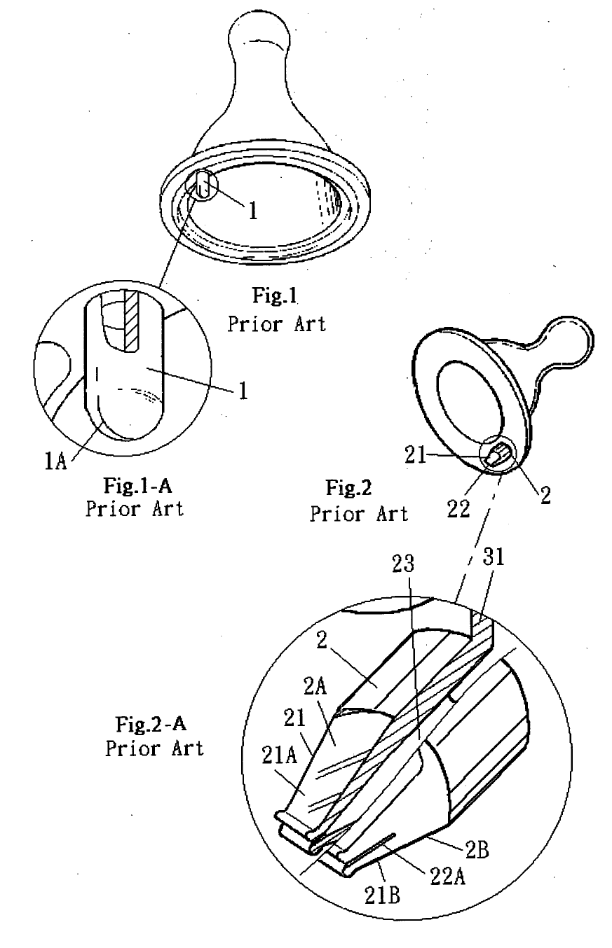

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

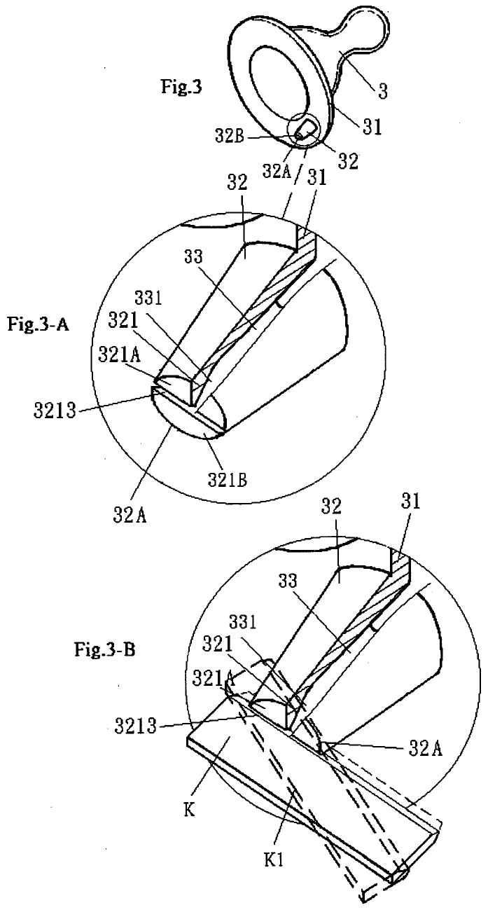

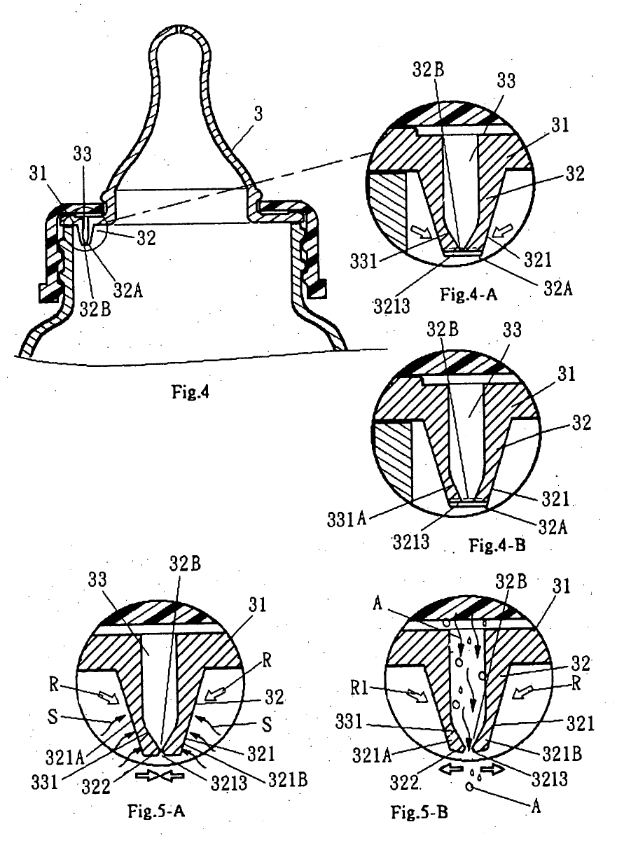

Referring to FIGS. 3, 3A, 4 and 4A, the present invention has the following elements.

A nipple 3 has an annular bottom 31. An air inlet valve 32 has a tapered shape with a flat bottom end 32A.

An air inlet channel 33 vertically penetrates the air inlet valve 32 and has a tip end. A distal end of the air inlet channel 33 is reduced so as to form a tapered reducing portion 331. A periphery of the air inlet channel 33 is formed with a tapered cylinder 321. One side of the tapered cylinder 321 near the bottom of the nipple 3 is thicker than other side of the tapered cylinder 321 for enhancing the structure of the air inlet valve 32.

A valve gate 321A and a valve gate 321B are formed at two sides of the flat bottom end 32A. A slit 3213 is formed between the valve gate 321A and the valve gate 321B. Referring to FIG. 3B, it is illustrated that the slit 3213 is formed by cutting a knife A. The slit 3213 is communicated to the air inlet channel 33.

Thereby, by the tension force R of the valve gate 321A and valve gate 321B, the slit 3213 is formed as a close portion 32B so that air or fluid S in the bottle can not flow out along a reverse direction, as shown in FIG. 5A.

When air A flows into the air inlet channel 33, the close portion 32B will be expanded by air pressure of air A so that the slit is opened, see FIG. 5B. Thereby, pressures within the bottle and out of the bottle are balanced. Then, the pushing force R from the valve gate 321A and valve gate 321B will close the slit 3213 as illustrated in FIG. 5A.

Thus, from above description, it is known that by the present invention, the nipple can be made easily and effectively. Thereby, the close portion 32B can be precisely determined.

With reference to FIGS. 4B, the distal end of the air inlet channel 33 can be frustrated so as to have a flat distal end. Similarly, a valve gate 321A and a valve gate 321B are divided by a close portion 32B so as to have a drain-proof effect.

With reference to FIG. 3B, in the present invention, the slit 3213 may be inclined to a surface of the flat bottom end 32A by obliquely inserting the knife K1 into the tapered cylinder 321.

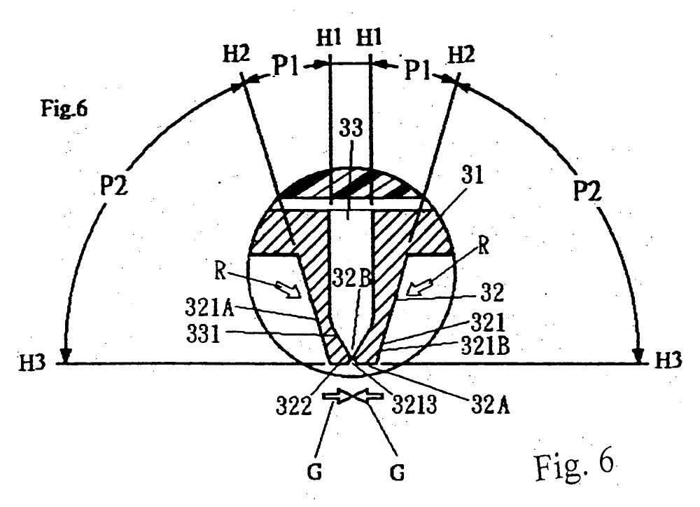

With reference to FIG. 6, it is illustrated that the tapered sleeved portion 321 has an air inlet channel 33 with a flat bottom end 32A. The lines H2 are extending lines from the outer walls of the tapered sleeved portion 321 and lines H1 are lines extending from the inner walls of the tapered sleeved portion 321. Lines H3 are lines along the surface of the flat bottom end 32A. Angles P1 are the angles between the H1 and the H2 and P2 are angles between H2 and H3. Forces R are forces applied to the tapered sleeved portion 321 from the outer sides and forces G are forces applied to the slits from the two outer sides. Other elements are same as the elements having same numerals indicated above.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An air inlet valve of a nipple used for a bottle; the nipple having an annular bottom; the air inlet valve having a tapered shape with a flat bottom end; the air inlet valve comprising:
an air inlet channel vertically penetrating through the air inlet valve and having a tip end; a distal end of the air inlet channel being reduced so as to form a tapered reducing portion; a periphery of another end of the air inlet channel being formed as a cylinder;
a tapered cylinder being formed to enclose the air inlet channel; one side of the tapered cylinder near the bottom of the nipple being thicker than other side of the tapered cylinder for enhancing the structure of the air inlet valve;
two valve gates formed at two sides of the flat bottom end; a slit being formed between the two valve gates; and the slit being communicated to the air inlet channel;
wherein by the tension force of the valve gates, the slit is closed so that air or fluid in the bottle can not flow out of the bottle along a reverse direction.

2. The air inlet valve of a nipple used for a bottle as claimed in claim 1, wherein a distal end of the air inlet channel is smoothed so as to have a flat distal end.

3. The air inlet valve of a nipple used for a bottle as claimed in claim 1, wherein the slit is inclined to a surface of the flat bottom end.
